(19) United States
(12) Patent Application Publication
(10) Pub. No.: US 2017/0153636 A1
(43) Pub. Date: Jun. 1, 2017

(54) Vehicle with wearable integration or communication

(71) Applicant: BRAGI GmbH, Munchen (DE)

(72) Inventor: Peter Vincent Boesen, München (DE)

(21) Appl. No.: 15/355,820

(22) Filed: Nov. 18, 2016

Related U.S. Application Data
(60) Provisional application No. 62/260,435, filed on Nov. 27, 2015.

(51) Int. Cl. G05D 1/00; G06F 1/16

(52) U.S. Cl. CPC G05D 1/0016; G06F 1/163

(57) ABSTRACT

A system includes a vehicle, the vehicle comprising a control system and a wireless transceiver operatively connected to the control system. The control system is configured to wirelessly communicate with a wearable device worn by a user using the wireless transceiver and the control system is configured to receive input from one or more sensors of the wearable device.

### PRIORITY STATEMENT

This application claims priority to U.S. Provisional Patent Application 62/250,435, filed on Nov. 27, 2015 and titled Vehicle with wearable integration or communication, hereby incorporated by reference in its entirety.

This application also claims priority to U.S. Provisional Patent Application 62/260,436, filed on Nov. 27, 2015 and titled Vehicle wick wearable for identifying one or more vehicle occupants, hereby incorporated by reference in its entirety.

This application also claims priority to U.S. Provisional Patent Application 62/260,437, filed Nov. 27, 2015, and titled Vehicle with wearable for identifying role of one or more users and adjustment of user settings, hereby incorporated by reference in its entirety.

This application also claims priority to U.S. Provisional Patent Application 62/260,438, filed on Nov. 27, 2015 and titled Vehicle with wearable to provide intelligent user settings, hereby incorporated by reference in its entirety.

This application also claims priority to U.S. Provisional Patent Application 62/260,439, filed on Nov. 27, 2015 and titled Vehicle with ear piece to provide audio safety, hereby incorporated by reference in its entirety.

This application also claims priority to U.S. Provisional Patent Application 62/260,440, filed on Nov. 27, 2015 and titled Vehicle with interaction between entertainment systems and wearable devices, hereby incorporated by reference in its entirety.

This application also claims priority to U.S. Provisional Patent Application 62/260,441, filed on Nov. 27, 2015 and titled Vehicle with interaction between vehicle navigation system and wearable devices, hereby incorporated by reference in its entirety.

This application also claims priority to U.S. Provisional Patent Application 62/260444, filed on Nov. 27, 2015 and titled Vehicle with interactions with wearable device to provide health or physical monitoring, hereby incorporated by reference in its entirety.

This application also claims priority to U.S. Provisional Patent Application 62/260,445, filed on Nov. 27, 2015 and titled Autonomous vehicle with interactions with wearable devices, hereby incorporated by reference in its entirety.

This application also claims priority to U.S. Provisional Patent Application 62/260,446, filed on Nov. 27, 2015 and titled Vehicle with display system for interacting with wearable device, hereby incorporated by reference in its entirety.

This application also claims priority to U.S. Provisional Patent Application 62/260,447, filed on Nov.27, 2015 and titled Vehicle to vehicle communications using ear pieces, hereby incorporated by reference in its entirety.

### FIELD OF THE INVENTION

The present invention relates to vehicles. More particularly, but not exclusively, the illustrative embodiments relate to a vehicle which it with or communicates with a wearable device such as an earpiece or a set of earpieces.

### BACKGROUND

Vehicles may come with various types of electronics packages. These packages may be standard or optional and include electronics associated with communications or entertainment. However, there are various problems and deficiencies with such offerings. What is needed are vehicles with improved electronics options which create, improve, or enhance the safety and overall experience of vehicles.

Therefore, it is a primary object, feature, or advantage of the illustrative embodiment improve over the state of the art.

It is another object, feature, or advantage of the illustrative embodiments to communicate between vehicle systems and wearable devices.

It is yet another object, feature, or advantage of the illustrative embodiments to allow an operator of a vehicle with an enclosed cabin to hear ambient sounds.

It is a further object, feature, or advantage of the illustrative embodiments to use wearable devices to increase safety in vehicles.

It is a still further object, feature, or advantage of the illustrative embodiments to allow for an operator of a vehicle to have to take a call while in the vehicle which is private from other passengers within the vehicle.

It is a further object, feature, or advantage to interface one or more earpieces to the audio system of a vehicle.

It is a still further object, feature, or advantage of the illustrative embodiments to allow a user to control one or more functions of a vehicle using one or more wearable devices such as earpieces.

It is a further object, feature, or advantage of the illustrative embodiments to allow a driver or passenger of a vehicle to text messages using a wireless earpiece.

It is a still further object, feature, or advantage of the illustrative embodiments to allow a vehicle to identify a driver based on the presence of a particular wearable device and to adjust driving preferences based on the identity of the driver.

Yet another object, feature, or advantage of the illustrative embodiments is to allow a vehicle to obtain biometric information about a driver or passenger using one or more wearable devices.

It is a further object, feature, or advantage of the illustrative embodiments to use the user interface of the vehicle to communicate with a wearable device.

It is another object, feature, or advantage of the illustrative embodiments to enhance an existing vehicle through addition of a wearable device.

It is a still further object, feature, or advantage of the illustrative embodiments to allow a vehicle to identify a driver based on the presence of a particular wearable device.

It is a still further object, feature, or advantage of the illustrative embodiments to allow a vehicle to identify one or more passengers of a vehicle based on the presence of particular wearable devices.

Yet another object, feature, or advantage of the illustrative embodiments is to allow a vehicle to obtain biometric information about a driver or passenger using one or more wearable devices.

It is another object, feature, or advantage of the illustrative embodiments to enhance an existing vehicle through addition of a wearable device.

It is a still further object, feature, or advantage of the illustrative embodiments to allow a user to control one or more functions of a vehicle using one or more wearable devices, such as ear pieces, watches, or glasses.

Another object, feature, or advantage of the illustrative embodiments is to allow a vehicle to identify not just a user but also the role of the user such as whether the user is a driver or passenger.

Yet another object, feature, or advantage of the illustrative embodiments is to allow for adjustment of user settings once a user has been identified.

A further object, feature, or advantage of the illustrative embodiments is to allow for a passenger to adjust different settings than a driver once the user(s) and their roles have been identified.

It is another object, feature, or advantage of the illustrative embodiment to communicate between vehicle systems and wearable devices.

It is a further object, feature, or advantage of the illustrative embodiments to use wearable devices within vehicles and to provide enhanced vehicle functionality.

It is another object, feature, or advantage of the illustrative embodiments to enhance the entertainment system of a vehicle.

It is a further object, feature, or advantage of the illustrative embodiments to use wearable devices within vehicles and to provide enhanced vehicle functionality.

It is another object, feature, or advantage of the illustrative embodiments to enhance the navigation system of a vehicle.

It is another object, feature, or advantage of the illustrative embodiments to enhance the safety of a vehicle using wearable devices.

It is a further object, feature, or advantage of the illustrative embodiments to use wearable devices within autonomous vehicles and to provide enhanced vehicle functionality.

It is another object, feature, or advantage of the illustrative embodiments to enhance the safety of an autonomous vehicle using wearable devices.

It is another object, feature, or advantage of the illustrative embodiments to collect information from a vehicle and to communicate to a wearable device such as an earpiece.

It is yet another object, feature, or advantage to allow for a vehicle display to be used to display data from an earpiece or other wearable device.

It is a further object, feature, or advantage of the illustrative embodiments to use wearable devices within vehicles and to provide enhanced vehicle functionality.

It is another object, feature, or advantage of the illustrative embodiments to collect information from a vehicle and to communicate to a wearable device such as an earpiece.

One or more of these and/or other objects, features, or advantages of the illustrative embodiments will become apparent from the specification and claims that follow. No single embodiment need provide each and every object, feature, or advantage. Different embodiments may have different objects, features, or advantages. Therefore, the illustrative embodiments are not to be limited to or by an object, feature, or advantage stated herein.

According to one aspect, a system includes a vehicle comprising a control system and a wireless transceiver operatively connected to the control system. The control system is configured to wirelessly communicate with a wearable device worn by a user using the wireless transceiver and the control system is configured to receive input from one or more sensors of the wearable device.

According to another aspect, a system includes a vehicle comprising a control system and a wireless transceiver operatively connected to the control system. The control system is configured to wirelessly communicate with a wearable device worn by a user using the wireless transceiver. The control system is configured to receive biometric input from one or more sensors of the wearable device to identify an occupant of the vehicle or individual proximate the vehicle.

According to another aspect, a system includes a vehicle comprising a control system, a first wireless transceiver operatively connected to the control system, a wearable device for being worn by a user, and a second wireless transceiver disposed within the wearable device configured to wirelessly communicate with the first wireless transceiver. The wearable device includes at least one sensor for obtaining biometric input. The wearable device is configured to identify a wearer of the wearable device using the biometric input and convey an identity of the wearer of the wearable device to the control system.

According to another aspect, a system includes a vehicle comprising a vehicle network with a plurality of devices in operative communication with the vehicle network and a wireless transceiver operatively connected to the vehicle network. The wireless transceiver is configured to wirelessly communicate with a wearable device worn by a user and after the user is identified, convey sensor data from the wearable device over the vehicle network to one or more of the plurality of devices.

According to another aspect, a method includes obtaining sensor data at a wearable device, determining a user's identity based on the sensor data and if the user has appropriate access rights, communicating data or commands over a vehicle network to perform vehicle functions.

According to another aspect, a system includes a vehicle comprising a control system and a wireless transceiver operatively connected to the control system. The control system is configured to both wirelessly communicate with a wearable device worn by a user using the wireless transceiver and receive input from one or more sensors of the wearable device.

According to another aspect, a system includes a vehicle having a vehicle network and a wearable device in operative communication with the vehicle network, wherein the wearable device includes one or more sensors for receiving sensor data. The system is configured to determine a role of a user of the wearable device within the vehicle. The role of the user may be determined either by either the wearable device or the vehicle. The role may be that of a driver or a passenger or based on seat location within the vehicle. Access rights may be assigned to the user based on their role. The system may also be configured to determine an identity of the user The access rights may be assigned to take into account both the role of the user and the identity of the users and may also take into account other individuals within the vehicle when making this determination. The vehicle may be configured to automatically adjust one or more user settings based on the identity of the user and the role of the user. Examples of such user settings may include seat adjustment settings, entertainment system settings, rear view mirror settings, temperature control settings, or navigation system settings including saved locations. The wearable device may be one or more earpieces, a watch, glasses, or another type of wearable device. The wearable device may include an inertial sensor and the vehicle may correlate sensor data from the inertial sensor to an interaction with the vehicle to determine the role of the user. Examples of interactions may include opening a door or touching a steering wheel or other part of a vehicle. The wearable device may include a first wireless earpiece and a second wireless earpiece, wherein each wireless earpiece has a wireless transceiver and the system may be configured to determine the role of the user by locating the user within the vehicle by using a signal from the first wireless transceiver and a signal from the second wireless transceiver.

According to another aspect, a method for identifying a role of one or more users within a vehicle is provided. The method may include identifying one or more users within the vehicle based on data from wearable devices and identifying roles of one or more of the users within the vehicle using the wearable. The method may further include adjusting one or more vehicle settings based on identity and role of the one or more users.

According to another aspect, a system includes a vehicle having a vehicle network. The system further includes a wearable device in operative communication with the vehicle network. The vehicle is configured to determine user settings for the vehicle from data received from the wearable device and implement the user settings for the vehicle. The data may be biometric data such as biometric data determined using one or more sensors of the wearable device such as a physiological sensor or inertial data. The biometric data may also be stored on the wearable device. The user settings may include settings such as steering wheel settings, seat settings, environmental control settings, or entertainment settings.

According to another aspect, a method for adjusting user settings associated with a vehicle based on data from a wearable device is provided. The method includes acquiring user data from a wearable device at a vehicle and based on the user data, determining one or more user settings via the vehicle. The method may further include automatically adjusting, via the vehicle, one or more vehicle features based on one or more of the user settings. The acquiring user data from the wearable device at a vehicle may be performed by operatively communicating the user data over a wireless linkage between the wearable device and the vehicle. The data may be biometric data. The user settings may include any number of settings such as seat position settings or entertainment system settings such as radio presets. The wearable device may include a physiological sensor and/or an inertial sensor.

According to one aspect, an earpiece includes an earpiece housing, a speaker associated with the earpiece housing, a microphone associated with the earpiece housing, a wireless transceiver disposed within the earpiece housing, and an intelligent control system disposed within the earpiece housing The earpiece is configured to connect with a vehicle using the wireless transceiver and after connection with the vehicle automatically enter a driving mode. In the driving mode, the earpiece senses ambient sound with the microphone and reproduces the ambient sound at the speaker. The earpiece may provide for persistently maintaining the driving mode while a user of the earpiece is driving the vehicle. The earpiece may be locked in the driving mode while a user of the earpiece is driving the vehicle. The earpiece is further configured to receive audio from one or more microphones of the vehicle. One or more of the microphones of the vehicle may be outside of a vehicle cabin of the vehicle. One or more of the microphones of the vehicle may be within a vehicle cabin of the vehicle. The intelligent control system may be adapted to process the ambient sound to remove noise. The intelligent control system may be adapted to combine the ambient sound, and an audio stream. The intelligent control system may be adapted to reduce the amplitude of the ambient sound and/or increase the amplitude of the ambient sound or portions thereof.

According to another aspect, a system includes a set of earpieces comprising at least one of a left earpiece and a right earpiece, each of the earpieces comprising an earpiece housing, a speaker, a microphone, an intelligent control system operatively connected to the microphone and the speaker, and a transceiver disposed within the earpiece housing and operatively connected to the intelligent control system, wherein the intelligent control system is configured to provide a driving mode wherein in the driving, mode ambient sound sensed with the microphone of the earpiece is reproduced at the speaker of the earpiece. The system further includes a vehicle in operative communication with the earpiece and wherein the vehicle is configured to set the driving mode of each of the set of earpieces. Each of the earpieces may be configured to receive audio from one or more microphones of the vehicle. One of the microphones of the vehicle may be outside of a vehicle cabin of the vehicle. One of the microphones of the vehicle may be within a vehicle cabin of the vehicle. The intelligent control system may be adapted to process the ambient sound to remove noise. The intelligent control system may be adapted to combine the ambient sound and an audio stream. The audio stream may be from an entertainment system of the vehicle. The intelligent control system may be adapted to reduce or increase amplitude of the ambient sound or portions thereof.

According to another aspect, a method includes providing an earpiece comprising an earpiece housing, a speaker, a microphone, an intelligent control system operatively connected to the microphone and the speaker, and a transceiver disposed within the earpiece housing and operatively connected to the intelligent control system. The method further includes communicating data from a vehicle to the earpiece to put the earpiece into a driving mode. In the driving mode the ambient sound sensed with the microphone of the earpiece is reproduced at the speaker of the earpiece. The method may further include providing the vehicle, wherein the vehicle comprises a vehicle transceiver for operative communication with the transceiver of the earpiece. The method may further include communicating an audio stream from the vehicle to the earpiece. The method may further include combining the audio stream from the vehicle with is the ambient sound at the earpiece. The method may further include receiving audio from one or more vehicle microphones and communicating an audio stream containing the audio from the vehicle to the earpiece. At least one of the vehicle microphones may be within a vehicle cabin of the vehicle. At least one of the vehicle microphones may be outside of the vehicle cabin of the vehicle. The processing of the ambient sound at the earpiece may be used to change audio characteristics of the ambient sound. The audio characteristics may include the amplitude or volume of the ambient sound and the processing may include increasing or decreasing the volume of the ambient sound or portions thereof.

According to another aspect, a system includes a vehicle, a vehicle network disposed within the vehicle, and an entertainment system disposed within the vehicle, wherein the entertainment system comprises at least one audio source. The entertainment system is configured to wirelessly communicate with at least one wireless earpiece to provide for streaming of audio to and from the at least one wireless earpiece. The entertainment system may be further configured to transfer audio files to the at least one wireless earpiece. The entertainment system may be further configured to transfer audio files from the at least one wireless earpiece. The entertainment system may be further configured to receive a playlist transferred from the at least one wireless earpiece and to perform an analysis of the playlist and determine one or more entertainment system settings based on the analysis. The settings may include radio station presets such as for satellite radio. The entertainment system may also be configured to send a playlist to the at least one wireless earpiece, to send audio preferences to the at least one wireless earpiece, and or to receive audio preferences from the at least one wireless earpiece. The entertainment system may communicate with multiple sets of earpieces associated with multiple occupants within the vehicle such as to receive at least one playlist transferred front each of the multiple sets of earpieces or to perform an analysis which combines each playlist from each of the multiple sets of earpieces and determine one or more entertainment systems based on the analysis. The audio source may be a CD player, a DVD player, a FM radio, a television receiver, a satellite radio, a solid state memory containing audio files, a magnetic memory containing audio files, or any number of other audio sources.

According to another aspect, a method for providing entertainment to one or more occupants within a vehicle is provided. The method includes providing a vehicle having an entertainment system, wirelessly connecting the entertainment system of the vehicle to at least one wireless earpiece associated with an occupant within the vehicle, and streaming audio from the at least one wireless earpiece to the entertainment system of the vehicle. The method may further include transferring one or more audio files from the at least one wireless earpiece to the entertainment system of the vehicle, transferring one or more audio files from the entertainment system of the vehicle to the at least one wireless earpiece, communicating a playlist from the at least one wireless earpiece to the entertainment system of the vehicle, performing an analysis of the playlist and determining one or more entertainment system settings based on the analysis or communicating a playlist from the entertainment system of the vehicle to the at least one wireless earpiece.

According to one aspect, a system includes a vehicle, a vehicle network disposed within the vehicle, and a navigation system disposed within the vehicle. The navigation system is configured to wirelessly communicate with at least one wireless earpiece to communicate navigation data to or from the at least one wireless earpiece. The navigation data includes a geospatial position. The navigation data include directions. The directions may include a first subset of directions for directions for use when driving the vehicle and a second subset of directions for directions for use when walking. The navigation data may include destination dater. The navigation data may include calibration data. The system may further include at least one wireless earpiece and the at least one wireless earpiece may comprise an inertial sensor. The earpiece may include an intelligent control system operatively connected to the inertial sensor and wherein the intelligent control system is configured to update a current position based on changes in position determined by the inertial sensor. The intelligent control system may be configured to calibrate with a geospatial position when the earpiece is within the vehicle. The intelligent control system may be configured to calibrate with a geospatial position when the earpiece is worn by a driver of the vehicle seated in a driver's seat. The navigation data may include an offset defining a distance between a geolocation system antenna of the vehicle and a position for use in calibration of the at least one wireless earpiece.

According to another aspect, a method of navigation using a vehicle navigation system of a vehicle and a wearable device is provided. The method may include computing directions from a current location to a destination using the vehicle navigation system wherein a first part of the directions are driving directions to an intermediate location and wherein a second part of the directions are walking directions from the intermediate location to the destination and electronically handing off navigation from the vehicle navigation system to the wearable device such that the wearable device provides the walking directions from the intermediate location to the destination after arrival at the intermediate location. The wearable device may be an earpiece or instead of a wearable device a mobile device such as a phone may be used. The device may include a geolocation receiver such as a GPS receiver or may include at least one inertial sensor for tracking movement. The method may include calibrating position of the wearable device to position of the vehicle. The method may include calibrating orientation of the wearable device to the position of the vehicle.

According to another aspect, a system includes a vehicle, a vehicle network disposed within the vehicle, and an earpiece comprising an earpiece housing, a physiological monitoring sensor, an intelligent control system operatively connected to the physiological monitoring sensor and disposed within the earpiece housing, and a wireless transceiver disposed within the earpiece housing and operatively connected to the intelligent control system. The vehicle is configured to receive health data from the earpiece. The physiological monitoring sensor may include one or more of an inertial sensor, a glucose sensor, an alcohol sensor, a temperature sensor, or a pulse oximeter. The vehicle may determine the presence of a health condition based on the health data and perform an action to improve safety of the vehicle. The action may include actions such as disabling the vehicle, playing an audio message, placing a phone call, mapping a destination using a navigation system of the vehicle, adjusting an audio setting to increase volume, opening a window of the vehicle, and/or adjusting a temperature setting of the vehicle. The earpiece may determine a presence of a health condition based on the health data and communicate an alert to the vehicle and the vehicle may perform an action to improve the safety of the vehicle in response to the health condition.

According to another aspect, a method may include sensing physiological data at one or more physiological sensors of an earpiece of a vehicle occupant, wirelessly communicating a representation of the physiological data from the earpiece to a vehicle network of the vehicle, and performing an action by the vehicle in response to the physiological data to enhance the safety of the vehicle. The physiological data may include pulse oximeter data, inertial sensor data, temperature data, glucose sensor data, and/or data from other types of sensors.

According to another aspect, a system includes a vehicle having functionality for autonomous operation, a vehicle network disposed within the vehicle and an earpiece comprising an earpiece housing, a physiological monitoring sensor, an intelligent control system operatively connected to the physiological monitoring sensor and disposed within the earpiece housing, and a wireless transceiver disposed within the earpiece housing and operatively connected to the intelligent control system. The vehicle is configured to receive health data from the earpiece and in response to the health data perform one or more functions independent of a vehicle occupant using the earpiece. The physiological monitoring sensor may be an inertial sensor, a glucose sensor, an alcohol sensor, a temperature sensor, a pulse oximeter, or another type of sensor. The vehicle may be configured to determine presence of a health condition based on the health data and lock vehicle controls to prevent the vehicle occupant from operating the vehicle controls or to change destination settings to a nearest emergency room or pull over and place a call to an emergency responder.

According to another aspect, a method includes sensing physiological data at one or more physiological sensors of an earpiece of a self-driving vehicle occupant, wirelessly communicating a representation of the physiological data from the earpiece to a vehicle network of the self-driving vehicle, and performing an action by the self-driving vehicle in response to the physiological data and independently from the occupant to enhance the safety of the self-driving vehicle. The physiological data comprises pulse oximeter data, inertial sensor data, temperature data, glucose sensor data, and/or other data. The action may be to lock driver controls to prevent the occupant from over-riding autonomous operation or other action or actions.

A system includes a vehicle, a vehicle network disposed within the vehicle, and a vehicle display operatively connected to the vehicle network. The vehicle network is configured to wirelessly communicate with at least one wireless earpiece to receive data from the at least one wireless earpiece and to display information associated with the at least one wireless earpiece on the vehicle display. The vehicle may be further configured to access audio files from the at least one wireless earpiece and display information about the audio files on the vehicle display. The vehicle may be further configured to access a playlist from the at least one wireless earpiece and display the playlist on the vehicle display. The vehicle may be further configured to access health monitoring data from the at least one wireless earpiece and display information about the health monitoring data on the vehicle display. The vehicle may be further configured to access a destination from the at least one wireless earpiece and display the destination on the vehicle display. The vehicle display, may be a touchscreen display and the vehicle may be further configured to receive input from an occupant wearing the at least one wireless earpiece using the touch screen display and communicate the input to the at least one wireless earpiece.

According to another aspect, a method for communicating information to a wireless earpiece of an occupant within a vehicle is provided. The method includes providing a vehicle having a vehicle display in operative communication with a vehicle network of the vehicle, wirelessly connecting the vehicle to the wireless earpiece of the occupant within the vehicle, and receiving data from the wireless earpiece and displaying the data on the vehicle display of the vehicle. The data may be one or more audio files stored on the wireless earpiece or a playlist stored on the wireless earpiece or health monitoring data or a destination location stored on the wireless earpiece. The vehicle display may be a touchscreen display and the method may further include receiving input from the occupant of the vehicle at the touchscreen display and sending the input to the wireless earpiece.

According to another aspect, a system includes a vehicle, a vehicle network disposed within the vehicle, and at least one earpiece for use within the vehicle. The vehicle is configured to wirelessly communicate with the at least one wireless earpiece within the vehicle. The vehicle is configured to wirelessly communicate with at least one wireless earpiece within a separate and is independent vehicle. The at least one earpiece for use within the vehicle may be used to determine a warning condition based on sensed data from an inertial sensor. The vehicle network may be configured to electronically send a warning message to the wireless earpiece within the separate and independent vehicle. The vehicle network may be configured to electronically receive a warning message from the wireless earpiece within the separate and independent vehicle. The at least one earpiece may include a health monitoring sensor and may be configured to determine a warning condition based on sensed data from the health monitoring data.

According to another aspect, a method includes sensing data with a sensor of a wireless earpiece within a first vehicle to provide sensed data, determining by the wireless earpiece within the first vehicle an alert condition based on the sensed data, and wirelessly communicating a message from a wireless earpiece within a first vehicle to a wireless earpiece within a second vehicle, the message indicating occurrence of the alert condition. The sensor may be an inertial sensor and the sensed data may be inertial data. The sensor may be a physiological sensor and the sensed data may be physiological data.

According to another aspect, a method includes sensing data with a sensor of a wireless earpiece within a first vehicle to provide sensed data, determining by the wireless earpiece within the first vehicle an alert condition based on the sensed data, and wirelessly communicating a message from a wireless earpiece within a first vehicle to a second vehicle, the message indicating occurrence of the alert condition. The sensor may be an inertial sensor and the sensed data may be inertial data. The sensor may be a physiological sensor and the sensed data may be physiological data.

### BRIEF DESCRIPTION OF THE DRAWINGS

FIG, 1 illustrates one example of use of a wearable device in conjunction with a vehicle.

FIG. 2 illustrates a wearable device in the form of a set of earpieces.

FIG. 3 is a block diagram illustrating a device.

FIG. 4 illustrates a vehicle network or bus allowing different electronic modules to communicate with a wearable device.

FIG. 5 illustrates a flowchart of a method for determining user identity and user role.

FIG. 6 illustrates a wearable device in operative communication with a vehicle network.

FIG. 7 illustrates a wearable device in communication with various vehicle systems through a vehicle network.

FIG, 8 illustrates a flowchart of a method of reproducing ambient sound while in a driving mode.

FIG. 9 illustrates a second embodiment of a wearable device in communication with various vehicle systems through a vehicle network.

FIG. 10 illustrates a pair of earpieces associated with an occupant of a first vehicle in operative communication with. a pair of earpieces associated with an occupant of a second vehicle.

### DETAILED DESCRIPTION

Some of the most important factors in selecting a vehicle such as car may be the technology available to enhance the experience. This may be of particular importance in certain vehicle segments such as for luxury vehicles. Another important factor in selecting a vehicle may be the available safety features. According to various aspects, the illustrative embodiments allow for wearable devices including earpieces to enhance the experience of vehicles and according to some aspects, the illustrative embodiments allow for wearable devices such as earpieces to enhance the overall safety of the vehicle. Therefore, it is expected that the technology described herein will make any vehicle so equipped more desirable to customers, more satisfying to customers, and potentially more profitable for the vehicle manufacturer. Similarly, at least some of the various aspects may be added to existing vehicles as after-market accessories to improve the safety or experience of existing vehicles.

FIG. 1 illustrates one example of a use of a wearable device in conjunction with a vehicle. As shown in FIG. 1 there is a vehicle 2. Although the vehicle shown is a full-size sedan, it is contemplated that the vehicle may be of any number of types of cars, trucks, sport utility vehicles, vans, mini-vans, automotive vehicles, commercial vehicles, agricultural vehicles, construction vehicles, specialty vehicles, recreational vehicles, buses, motorcycles, aircraft, boats, ships, yachts, trains, spacecraft, or other types of vehicles. The vehicle may be gas-powered, diesel-powered, electric, solar-powered, or human-powered. The vehicle may be actively operated by a driver or may be partially or completely autonomous or self-driving. The vehicle 2 may have a vehicle control system 40. The vehicle control system 40 is a system which may include any number of mechanical and electromechanical subsystems. As shown in FIG. 1, such systems may include a navigation system 42, a climate control system 43, an entertainment system 44, a vehicle security system 45, an audio system 46, a safety system 47, a communications system with a wireless transceiver 48, a driver assistance system 49, a passenger comfort system 50, and an engine/transmission/chassis electronics system(s) 51. Other types of vehicle control systems may be employed as well. In the automotive context, examples of the safety system 47 may include active safety systems such as air bags, hill descent control, and an emergency brake assist system. Furthermore, in the automotive context, examples of the driver assistance system 49 may include one or more subsystems such as a lane assist system, a speed assist system, a blind spot detection system, a park assist system, or an adaptive cruise control system and examples of the passenger comfort system 50 may include one or more subsystems such as automatic climate control, electronic seat adjustment, automatic wipers, automatic headlamps, and automatic cooling. Aspects of the navigation system 42, the entertainment system 44, the audio system 46, and the communications system 48 may be combined into an infotainment system. In addition, it is to be understood that there may be overlap between different vehicle control systems and the presence or absence of certain vehicle control systems may depend upon the type of vehicle, the type of fuel or propulsion system, the size of the vehicle, and other factors and variables.

One or more wearable devices 10 such as a set of earpieces including a left earpiece 12A and a right earpiece 12B may be in operative communication with the vehicle control system 40 via the communications system 48. The communications system 48 may communicate with the wearable devices 10 directly or through a mobile device 4 such as a mobile phone, a tablet, or other type of mobile device. For example, the communications system 48 may provide a Bluetooth or BLE link directly to the wearable devices or may provide a Bluetooth or BLE link to a mobile phone in operative communication with either the left earpiece 12A or the right earpiece 12B.

As will be explained in further detail with respect to various examples, the wearable devices 10 may interact with the vehicle control system 40 in any number of different ways. For example, the wearable devices 10 may provide sensor data, identity information, stored information, streamed information, or other types of information to the vehicle 2. Based on this information, the vehicle 2 may take, any number of actions which may include one or more actions taken by the vehicle control system 40 (or subsystems thereof). In addition, the vehicle 2 may communicate sensor data, identity information, stored information, streamed information or other types of information to the wearable devices 10.

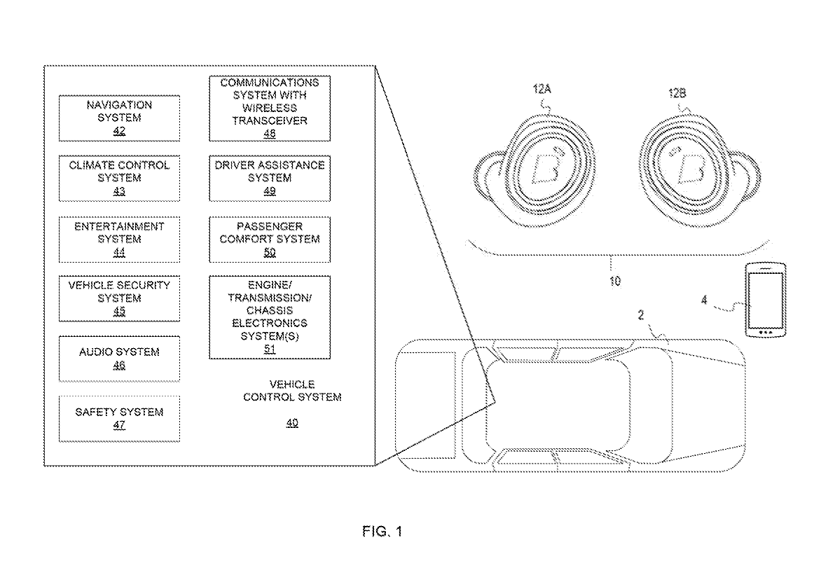

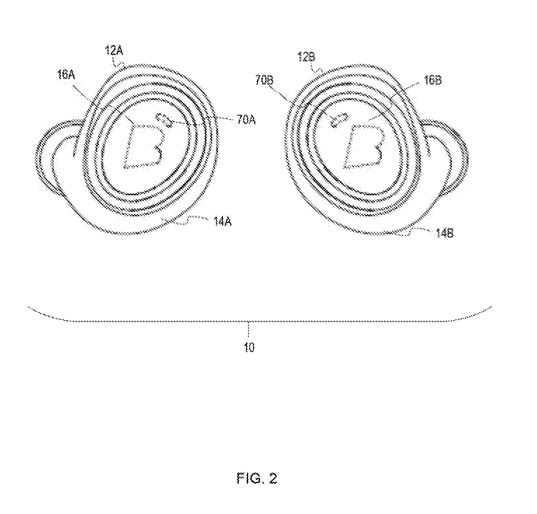

FIG. 2 illustrates one example of a wearable device 10 in the form of a set of earpieces in greater detail. FIG. 2 illustrates a set of earpieces which includes a left earpiece 12A and a right earpiece 12B. Each of the earpieces 12A, 12B has an earpiece housing 14A, 14B which may be in the form of a protective shell or casing and may be an in-the-ear earpiece housing. Each earpiece 12A, 12B may also include one or more microphones 70A, 70B. Note that the microphones 70A, 70B are outward facing such that the microphones 70A, 70B may capture ambient environmental sound. It is to be understood that any number of microphones may be present including air conduction microphones, bone conduction microphones, of other audio sensors. A left infrared-through-ultraviolet spectrometer 16A and right infrared-through-ultraviolet spectrometer 16B is also shown. Each infrared-through-ultraviolet spectrometer 16A, 16B may measure electromagnetic radiation from an outside source to be used in one or more functions of earpieces 12A, 12B.

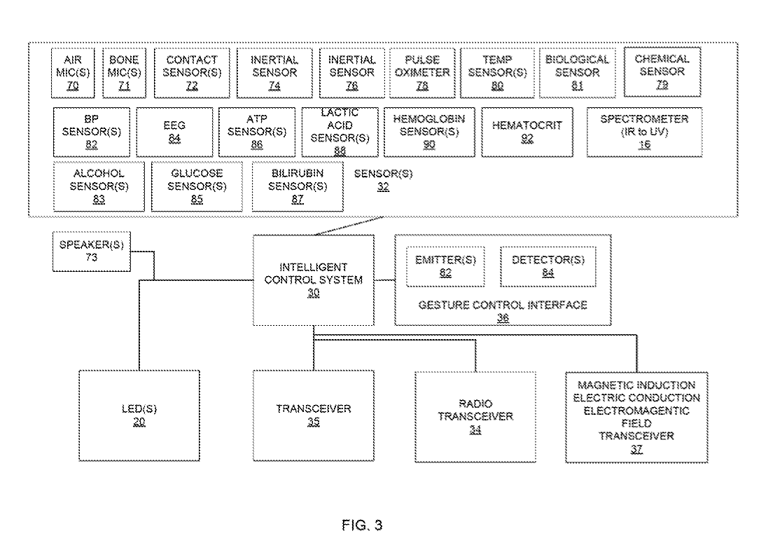

FIG. 3 is a block diagram illustrating the components of a wearable device 10. The wearable device 10 may include one or more LEDs 20 electrically connected to an intelligent control system 30. The intelligent control system 30 may include one or more processors, microcontrollers, application specific integrated circuits, or other types of integrated circuits. The intelligent control system 30 may also be electrically connected to one or more sensors 32. Where the wearable device 10 is an earpiece, the sensor(s) 32 may include inertial sensors 74 and 76, wherein each inertial sensor 74, 76 may comprise an accelerometer, a gyro sensor or gyrometer, a magnetometer, or another type of inertial sensor. The sensor(s) 32 may also include one or more contact sensors 72, one or more bone conduction microphones 71, one or more air conduction microphones 70, one or more chemical sensors 79, a pulse oximeter 78, a temperature sensor 80, an alcohol sensor 83, a glucose sensor 85, a bilirubin sensor 87, a blood pressure sensor 82, an electroencephalogram (EEG) 84, an Adenosine Triphosphate (ATP) sensor, a lactic, acid sensor 88, a hemoglobin sensor 90, a hematocrit sensor 92, or other physiological or chemical sensor.

A spectrometer 16 is also shown. The spectrometer 16 may be an infrared (IR) through ultraviolet (UV) spectrometer although it is contemplated that any number of wavelengths in the infrared, visible, or ultraviolet spectrums may be detected. The spectrometer 16 is preferably adapted to measure environmental wavelengths for analysis and recommendations and thus is preferably located on or at the external facing side of the wearable device 10.

A gesture control interface 36 is also operatively connected to or integrated into the intelligent control system 30. The gesture control interface 36 may include one or more emitters 82 and one or more detectors 84 for sensing user gestures. The emitters 82 may be of any number of types including infrared LEDs. The wearable device 10 may also include a transceiver 35 which may allow for transmissions via near field magnetic induction. A short range transceiver 34 using Bluetooth, BLE, UWB, or other means of radio communication may also be present. The short range transceiver 34 may be used, for example, to communicate with the vehicle control system 40. In operation, the intelligent control system 30 may be configured to convey different information using one or more of the LED(s) 20 based on context or mode of operation of the wearable device 10. The intelligent control system 30, sensors 32, and other electronic components may be located on the printed circuit board of the wearable device 10. One or more speakers 73 may also be operatively connected to the intelligent control system 30.

A magnetic induction electric conduction electromagnetic (E/M) field transceiver 37 or other type of electromagnetic field receiver is also operatively connected to the intelligent control system 30 to link the intelligent control system 30 to the electromagnetic field of the user. The E/M transceiver 37 may allow the device to link electromagnetically to a personal area network, a body area network, or another electronic device.

### Identifying One or More Users

According to one aspect, the wearable devices 10 may be used to identify one or more users, Each wearable device may include its own identifier. In addition, each wearable device may be used to determine or confirm the identity of an individual. For example, an individual may provide a sample of their voice via an air microphone 70 to the intelligent control system 30 of a wearable device 10, which may compare the sample with one or more voice samples previously provided by the individual to determine whether the current sample is associated with the identity of the individual.

Other types of user identification and authentication may also be used. For example, an individual may be asked to provide information to the wearable device 10 in order to confirm their identity. This may include answering specific questions. For example, the wearable device 10 may ask multiple yes/no or multiple choice questions which the individual will or is likely to know but others are not likely to know. These questions may be stored within a database and may be questions to which the individual has previously provided specific answers. These questions may also be based on one or more activities of the individual which are stored on the wearable device 10 or are retrievable from a system in operative communication with the wearable device 10. These questions may include information about physical activities, locations, or other activities. Alternatively, in lieu of performing the user identification and authentication, the wearable device 10 may communicate any voice samples or gestural responses provided by the individual to the vehicle 2, the mobile device 4. or another device for analysis.

Referring back to FIG. 1, once the individual has been identified the individual may be authorized to perform various functions regarding the vehicle 2. For example, the vehicle 2 may be unlockable via a voice command such as “unlock” or the vehicle 2 may be remote started and environmentally set via a voice command such as “start my car and set temperature to 72 degrees.” These actions may be taken by the vehicle control system 40 or by one or more of its subsystems such as an actuator or an ignition lock switch. In addition, the vehicle control system 40 or one or more of its subsystems make take actions based on either the proximity of the individual to the vehicle 2 or contextual information.

Referring to FIG, 4, a vehicle network 100 is shown. Once the identity of the individual has been established, the individual may also provide commands to perform one or more vehicle functions over the vehicle network 100 or vehicle bus using the wearable device(s) 10, which may include a left earpiece 12A and a right earpiece 12B. For example, if the individual wishes to move their seat back, the individual may state “move driver seat back” to the wearable device(s) 10 or one of the earpieces 12A, 12B, which may then communicate the command to the vehicle 2 via the vehicle network 100. The individual may also communicate with the vehicle network 100 using a mobile device 4. Protocols which are used may include a Controller Area Network (CAN), Local Interconnect Network (LIN), or others including proprietary network protocols or network protocol overlays.

In addition, various types of electronic control modules 102, 104, 106, 108 may also communicate over the vehicle network 100. These may include electronic control modules such as an engine control unit (ECU), a transmission control unit (TCU), an anti-lock braking system (ABS), a body control module (BCM), a door control unit (DCU), an electric power steering control unit (PCU), a human-machine interface (HMI), a powertrain control module (PCM), a speed control unit (SCU), a telematic control unit (TCU), a brake control unit (BCM), a battery management system, or other control modules not listed. Any number of electronic control modules may be operatively connected to the vehicle network 100. In addition, a wireless transceiver module 110 may also be operatively connected to the vehicle network 100 and configured to receive data from the wearable device(s) 10 once identity has been established. For example, data encoding information sensed by one or more sensors of the wearable device(s) 10 may be transmitted to the wireless transceiver module 110 for use by one or more components or electronic control modules (102, 104. 106, 108) of the vehicle 2.

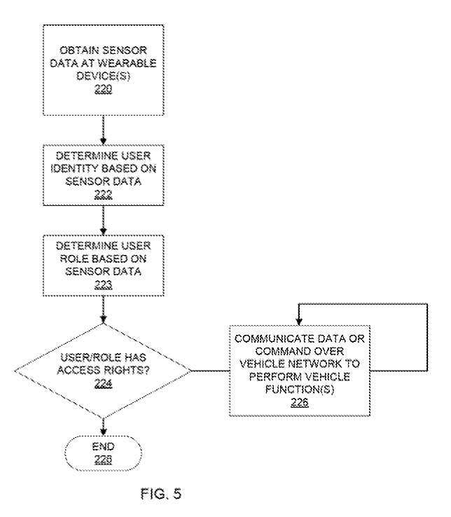

FIG. 5 illustrates a method. As shown in FIG. 5, at step 220, sensor data is obtained at one or more wearable devices. As previously explained the sensor data can be of any number of types. For example, the sensor data may be voice data or biometric data. In step 222, a determination is made of the user identity based on the sensor data. Where the sensor data is voice data this determination may be as the result of a voice print or voice sample analysis. Any number of different products or components may be used to perform this analysis. Examples of commercial products for performing such analysis include Nuance VocalPassword, VoiceIT, and numerous others. It should be further understood that other types of biometric data may be used. For example, inertial sensor data may be used to perform a gait analysis. Pulse oximeter data may be used to perform heart rate variability analysis or other types of biometric analysis may be performed. Where the wearable device is a pair of glasses then retinal identification and authentication may be used. Where the wearable device is a pair of gloves than fingerprint analysis may be used. The determination of the user identify based on sensor data may be performed in one of several different locations based on the type of analysis and available computational resources. For example, the determination ma be performed on or at the wearable device itself. Alternatively, the determination may be performed on or at the vehicle or even by a mobile device such as a smart phone which is in operative communication with either the vehicle or one or more of the wearable devices.

### Identifying the Role One or More Users and Adjustment of User Settings

Once the individual has been identified, in step 223, the role of the user may be determined based on sensor data or other data associated with one or more wearable devices. This determination may be performed in various ways. For example, data from one or more inertial sensors may be correlated with vehicle data. Thus, if sensor data shows a downward movement and an opening of a door of the vehicle, then this data may be correlated and a determination may be made that the user wearing the wearable device is the user that opened the door and entered the vehicle. If the door is the driver's door, the system may make the determination that that user is the driver. Similarly, if the sensor data shows user hand or wrist movement consistent with hand placement on a steering wheel, then the wearable device may infer that the user is the driver. Similarly, if the sensor data includes image information such as from a camera associated with the wearable device, that information may be processed to determine the role of the user. In addition, the wearable device may be used to determine a location such as a seat location of a user within the vehicle. The role may be determined based on the seat location.

Once the individual has been identified or recognized, in step 224 a determination is made as to whether the user has access rights. In one implementation, if the user is identified then the user has appropriate access rights. In alternative implementations, identifying the user does not necessarily give the individual all rights. Where the user has appropriate access rights or none are required, in step 226 data or commands may be communicated over the vehicle network to perform various vehicle functions. Data from the wearable device(s) may be used by any electronic control modules associated with the vehicle network to provide input to be used in any number of different decision-making processes. Similarly, commands may be given from the user to the vehicle using one or more wearable devices such as an earpiece. If the user does not have access rights, then in step 228 the user is denied access.

It is further contemplated that particular commands may be automatically communicated based on the identity of the user. In other words, once the user has been identified the vehicle may perform one or more vehicle functions automatically based on the identity of the user. These functions may be any number of different functions previously discussed including functions that grant or deny access to the user.

According to another aspect, one or more wearable devices may be used to identify an individual and the role of the individual as a driver or passenger of a vehicle. Once the driver has been identified a number of different actions may be taken by a vehicle control system. This may include automatically adjusting various settings within the vehicle based on user preferences. Thus, for example, seats may be adjusted to the position preferred by the user including adjusting the seat forward or back, adjusting the seat upward or downward, or adjusting the angle of the seat. Similarly, the position of the rearview mirrors or other mirrors may be adjusted based on preferences associated with a particular driver. In addition, steering wheel position may also be adjusted based on preferences associated with the particular driver. These various adjustments may be performed in various ways including through the use of servo motors or other types of motors, switches, or actuators.

Similarly, various other types of settings may be stored which are associated with a particular individual, who may be a passenger or the driver. These may include navigation settings. Thus, navigation settings associated with a particular individual may be used. For example, where an individual has previously identified a particular location (such as “Peter's house”) within the navigation system, those particular locations may be associated with the individual and automatically available. Locations associated with one or more individuals may also be added to the system as well.

Other types of settings such as radio station or satellite radio presets or favorites may also be loaded. Other settings associated with an entertainment system or infotainment system may also be loaded. Again, these settings may be associated with the driver and/or one or more passengers.

Various other types of settings may also be associated with a user. These settings may include door lock settings, climate settings, light settings, or any number of other personalized settings. These settings may further include other navigation settings and preferences, camera settings and preferences, vehicle settings and preferences, system settings and preferences, phone settings and preferences, information settings and preferences, audio settings and preferences, or any number of other electronic or electro-mechanical settings, preferences, or adjustments which may be made by the vehicle.

Where there is more than one individual within the vehicle with a wearable device, it is contemplated that a determination may made as to which individual is the driver and which individual or individuals are passengers. It is contemplated that this determination may be made in any number of ways. For example, where the wearable device is in the form of two earpieces, it is contemplated that the position of a particular user may be found within the vehicle by using directional range finding or similar techniques to determine position. Where the wearable device includes one or more inertial sensors, it is contemplated that the identity of one or more users may be determined based on movement of the user. For example, where the wearable device is a watch, movement of the wrist consistent with placing the hand on a steering wheel may be indicative of which user is the driver. Where the wearable device is a set of earpieces, the timing of the movement of the head relative to the opening and closing of the driver's door may be indicative of which user is the driver. Similarly, the timing of the movement of the bead relative to the opening and closing of a passenger's door may be indicative of which user is the passenger. In addition, a single individual may be associated with the vehicle as a primary driver with one or more other individuals associated as secondary drivers. Alternatively, the vehicle or wearable device may prompt one or more individuals to ask “Who is driving” or “Are you driving” or “Who is driving, Peter or Jim Senior?”

### Intelligent User Settings

According to another aspect, information from a wearable device way be used to improve the comfort and/or safety of a driver or passenger by suggesting user settings for optimum comfort, optimum safety, or both. Where a wearable device includes one or more physiological sensors and physiological data or biometric data is available, this data may be used to suggest specific user settings. For example, recommendations for seat settings based on the height of the user or the measurements of the individual's legs, torso, arm length, or other relevant parts of the user's body may be communicated by the wearable device to a vehicle.

One application of this aspect is when an individual wearing an appropriate wearable device enters a vehicle the first time, such as when selecting a vehicle to buy. Based on available biometric information from the wearable device, the vehicle may sells-adjust to settings consistent with the known biometric information to increase the comfort of the individual, better accommodate the individual, and provide an enhanced initial experience with the vehicle. Similarly, if an individual prefers other settings than those recommended, information about those settings may be communicated to the wearable device and communicated to other vehicles or other devices which the driver may operate.

Similarly, where the wearable device contains music such as a plurality of audio files or playlists, this information may be communicated to the vehicle and based on this information the vehicle may determine a set of radio presets based, for example, on one or more types of music communicated by the wearable device to the vehicle.

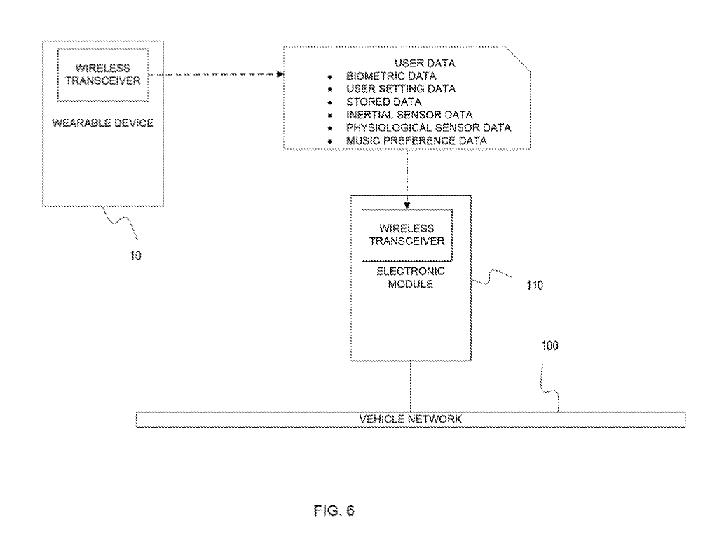

FIG. 6 illustrates another example of a system. As shown in FIG. 6, a wearable device 10 includes a wireless transceiver. The wearable device may be an earpiece, a set of earpieces, a watch, glasses, integrated into an article of clothing, or another type of wearable device. The wearable device 10 communicates user data to a wireless transceiver associated with an electronic module 110 of a vehicle. The user data may include biometric data, user setting data, stored data, inertial sensor data, physiological sensor data, music preference data, or other types of data. Such data may be translated into vehicle user settings and communicated to the appropriate modules over the, vehicle network 100. The modules may then automatically adjust one or more vehicle features or controls based on the vehicle user settings.

### Audio Safety

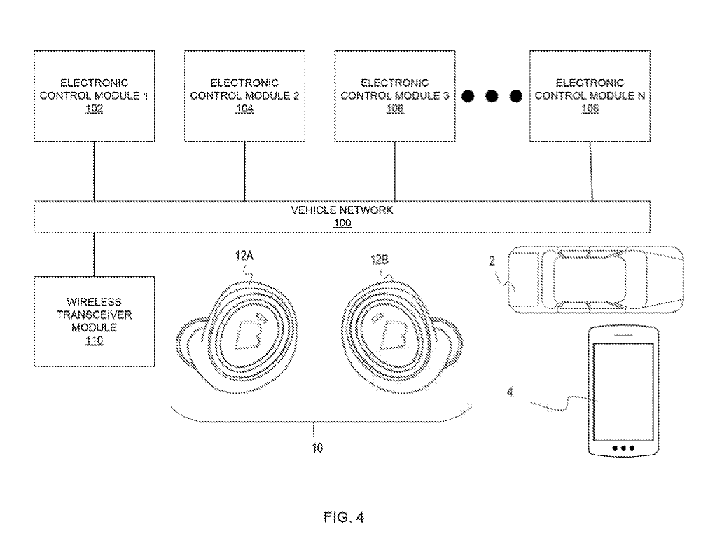

Referring to FIG. 4, the wireless transceiver module 110 operatively connected to the vehicle network 100 may be in operative communication with the wearable device 10 and may receive data from or transmit data to the wearable device 10 via the vehicle network 100. The wearable device 10 may include left earpiece 12A and right earpiece 12B, and the data communicated to or from the wireless transceiver module 110 may include instructions, commands, or audio streams. Once the wearable device 10 has communicated with the vehicle (such as through the wireless transceiver module 110), the wearable device 10 may enter a driver mode. In the driver mode or driving mode the wearable device 10 may provide for audio passthrough by reproducing audio detected with one or more microphones of the wearable device 10 at one or more speakers of the wearable device 10, allowing the user to hear ambient sounds.

It is generally accepted as dangerous for individuals operating a vehicle to wear head phones, ear buds, or other such devices which prevent individuals from being able to hear ambient sounds when operating vehicles. In addition, operating vehicles while wearing headphones or ear buds is generally prohibited by law. According to one aspect, a wearable device is in the form of a set of earpieces. The earpieces are configured to capture and reproduce ambient sounds audible to the operator. This may be accomplished by using one or more microphones on the earpieces to detect ambient sound and subsequently reproducing the ambient sound at one or more speakers of the earpieces. Thus, even though the operator is wearing earpieces there is audio transparency.

Where the driver is wearing earpieces the earpieces may lock themselves in a mode which provides for ambient noise pass-through. Thus, even though the driver is wearing earpieces the driver can hear ambient sound. In addition, the earpiece may provide for further processing in order to enhance ambient sounds to assist the driver in operating the vehicle. This enhancement may be performed in various ways including increasing the volume or amplitude of the ambient sounds.

It is further contemplated that in addition to one or more microphones on the earpiece itself, one or more additional audio streams may be sent to the earpieces from one or more microphones associated with the vehicle, These microphones may be positioned within the cabin of the vehicle or may be positioned at the exterior of the vehicle so as to pick up external noises. It is further contemplated that the earpieces and the vehicle may provide for intelligently determining when to reproduce particular audio streams. For example, when the driver shifts the vehicle into reverse, an audio stream from a microphone at the rear of the vehicle may be reproduced at the earpieces. Similarly, when the driver begins to shift lanes or signals a right turn or a left audio streams from the microphones of the vehicle may be reproduced at the earpiece. Or alternatively, when a driver performs particular actions as detected by the vehicle particular ambient noises may be amplified or otherwise emphasized.

One or more audio streams from an entertainment system of the vehicle or other vehicle system may also be combined with the ambient sound. It is contemplated that each audio stream may be paused or muted based on vehicle operations. Thus, for example, when the driver begins to shift lanes the audio stream may be paused or muted. Similarly, if the driver begins to back up the audio stream may also be paused or muted. Thus, as shown in FIG, 7, different information regarding vehicle states may be communicated to the wireless transceiver associated with an electronic module 110 and to the wireless transceiver associated with the wearable device 10 from the vehicle network 100 after the wireless transceiver associated with an electronic module 110 connects with one or more wearable device(s) 10. In addition, one or more audio streams from the vehicle network 100 may be communicated to the wearable device 10 such as audio streams from one or more in-cabin microphones 128, one or more exterior microphones 130, or the entertainment system 122. The wearable device 10 may then use this information to control or alter audio processing in a context appropriate manner. This may include increasing volume of a particular stream, decreasing volume of a particular stream, pausing, a particular stream, muting a particular stream, or stopping a particular stream. In addition, based on vehicle state, an additional audio stream may be communicated to the wearable device 10. The additional audio stream may include the playing an audio message associated with a vehicle function, alert condition, or other function or condition.

FIG. 8 illustrates one example of a method. As shown in FIG, 8, in step 230 one or more earpieces are provided. In step 232 data is communicated from the vehicle to the earpieces. In addition, data from the earpieces may be communicated to the vehicle. Once the earpieces are connected with the vehicle, in step 234 the earpieces are placed in a driving mode to reproduce ambient sound. In step 236, the ambient sound may be modified such as by combining the ambient sound with one or more audio streams. In step 238 the process ends.

Where ambient sound is reproduced directly or modified after processing safety can be enhanced through the use of earpieces. Various methods, system, and apparatus have been shown and described relating to vehicles with wearable integration or communication. The illustrative embodiments are not to be limited to these specific examples but contemplates any number of related methods, systems, and apparatus and these examples may vary based on the specific type of vehicle, the specific type of wearable device, and other considerations.

### Communications Privacy

According to another aspect, earpieces may be used to take phone calls within a vehicle. For example, there may be a set of earpieces and a vehicle as well as a mobile phone. Conventionally, one may take a phone call in a vehicle by pairing the phone to the vehicle such as using Bluetooth connectivity. In this way an individual may place and accept phone calls. Alternatively, where the vehicle includes its own telecommunications systems the individual may place and accept calls simply using the vehicle. One problem with this approach is that each individual within the vehicle may hear the entire conversation.

According to one aspect, when a phone call is received at the vehicle the individual may select to take the phone call at the earpieces. Thus, other individuals within the vehicle can, at best, hear only one side of the conversation. Where the earpieces include bone microphones and/or active cancellation, the privacy of the phone call can be further increased by turning on and/or increasing the audio system of the vehicle to play music or other audio for the benefit of others within the vehicle to further obscure the conversation. Thus, integrating, earpieces with other vehicle controls can further enhance the privacy of communications within the vehicle.

### Interaction between Entertainment Systems and Wearable Devices

Referring to FIG. 4, according to one aspect, the wearable devices 10 may communicate information through a vehicle network 100 associated with a vehicle 2. Data, instructions, commands, or audio streams may be communicated over the vehicle network 100 or vehicle bus to and from the wearable devices 10. Protocols which may be used, include a Controller Area Network (CAN), Local Interconnect Network (LIN), or others including proprietary network protocols or network protocol overlays.

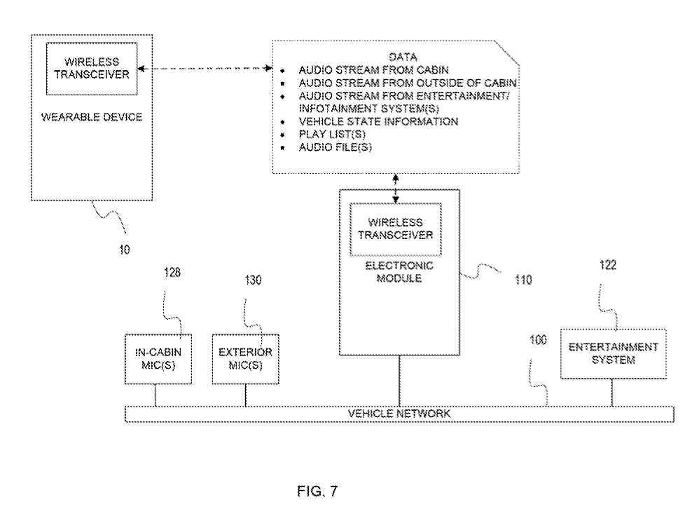

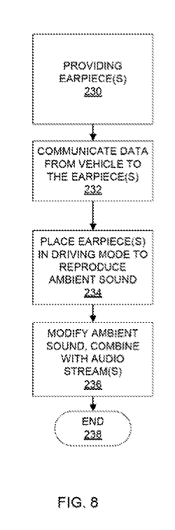

Referring to FIG. 7, in one embodiment a wireless transceiver associated with an electronic module 110 is operatively connected to a vehicle network 100 and in operative communication with one or more wearable devices 10. As shown in FIG. 7, one or more wearable devices 10 (including one or more earpieces from one or more different vehicle occupants) may communicate with an entertainment system 122 of a vehicle. Although the communication may be performed directly between the entertainment system 122 and one or more of the wearable devices 10, in one embodiment a wireless transceiver associated with the electronic module 110 may be operatively connected to one or more wearable devices 10 after the wireless transceiver associated with the electronic module 110 connects with or forms a wireless linkage with one or more of the wearable devices 10. The wireless transceiver associated with the electronic module 110 may use any number of different types of communications and protocols including Bluetooth, Bluetooth Low Energy (BLE), ultra-wideband, or otherwise.

According to another aspect, there are various forms of interaction between the entertainment system of the vehicle and one or more wearable devices. These may include interaction with the audio systems previously described as well as additional types of interactions. For example, according to one aspect, the wearable device may be one or more earpieces which store audio files. The vehicle may include an entertainment system that also stores audio files. One or more audio files or playlists may be transferred from the vehicle to the earpiece, Alternatively, one or more audio files or playlists may be transferred from the earpiece to the vehicle. In addition, one or more audio files or playlists may be streamed from the vehicle to the earpiece and one or more audio files or playlists may be streamed from the earpiece to the vehicle.

It is also contemplated that by communicating playlists or lists of audio files back and forth between the entertainment system and one or more earpieces that information contained within the playlists or lists of audio files may be analyzed in various ways such as to identify genres or artists of particular interest to an occupant of the vehicle. Such information may be is readily obtained as it may be stored within the playlist, as header information, or within an audio file. Alternatively, such information may be looked up from a local or remote database based on information which is readily identifiable and extractable from a playlist or audio file. Based on this information, entertainment system settings may be set according to one or more preferences of the occupant. For example, if all audio files within a playlist from an earpiece of an occupant of the vehicle are tagged as “Jazz,” then in analyzing, the playlist the entertainment system may determine that the occupant enjoys jazz music and may then arrange radio presets to favor jazz stations or presets or suggest jazz titles. Where multiple occupants are present within the vehicle with their own earpieces the entertainment system may obtain information from the earpieces of each occupant and build a playlist which includes music titles which all occupants listen to.

In addition, there may be one or more displays associated with the entertainment system of the vehicle. Where there are one or more displays associated with the entertainment system of the vehicle these may be used in conjunction with the wearable devices such as one or more earpieces. Thus, for example, the available audio files or music stored on the wearable devices may be displayed on one or more of the displays associated with the entertainment system of the vehicle.

### Interaction Between Vehicle Navigation Systems and Wearable Devices

Referring to FIG. 4, according to one aspect, the wearable devices 10 may communicate information through a vehicle network 100 associated with a vehicle 2. Data, instructions, geospatial positions, or routing information may be communicated over the vehicle network 100 or vehicle bus to and from the wearable devices 10. Protocols which may be used include a Controller Area Network (CAN), Local Interconnect Network (LIN), or others including proprietary network protocols or network protocol overlays.

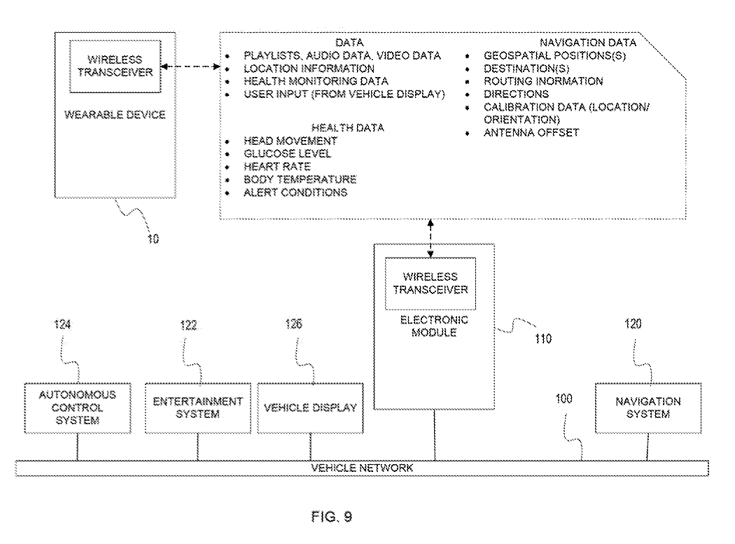

As shown in FIG. 9, one or more wearable devices 10 (including one or more earpieces from one or more different vehicle occupants) may communicate with a navigation system 120 of a vehicle. Although the communication may be performed directly between the navigation system 120 and one or More wearable devices 10, in one embodiment a wireless transceiver associated with an electronic module 110 may be operatively connected to one or more wearable devices 10 after the wireless transceiver associated with the electronic module 110 connects with or forms a wireless linkage with one or more of the wearable devices 10. The wireless transceiver associated with an electronic module 110 may use any number of different types of communications and protocols including Bluetooth, Bluetooth Low Energy (BLE), ultra-wideband, Wi-Fi, or other protocols.

According to another aspect, there may be various forms of interaction between the navigation system of the vehicle and one or more wearable devices. In particular, a navigation system associated with one or more wearable devices such as a pair of earpieces may integrate with the navigation system of the vehicle.

According to one e ample, one or More earpieces may provide a voice assistant for providing instructions to a user but, one or more of the earpieces may not have a geolocation system such as a global positioning system (GPS) receiver or GLOSNASS receiver or other geolocation system. However, one or more of the earpieces may each have one or more inertial sensors which may be used to track movement of an individual. Thus, to determine geolocation or geospatial position, one or more of the earpieces may communicate with a mobile device or vehicle navigation system which includes a geolocation system. It is further contemplated that once an earpiece knows of or is calibrated to a particular geoposition, the earpiece may use information from its inertial sensors to update or track changes in its geoposition.

For example, when an individual is sitting in a vehicle (or otherwise proximate to the vehicle), one or both of the earpieces may request and/or receive geoposition information from the vehicle. Thus, the earpiece may use the geoposition information to calibrate or re-calibrate itself to an accurate geoposition, it is contemplated that the more precise the geoposition information, the more precise the individual's calibrated position with an appropriate offset between the position of the GPS antenna of the vehicle and the position of the earpieces(s) (or other wear able device).

In addition to calibrating. location, calibration, may include orientation or heading information. Thus, not only is the position used but the direction the vehicle (and a driver of the vehicle seated in the driver's seat) is facing may also be used for calibration.

The wearable device may also provide directions to a user in various ways. This may include providing voice feedback to the user regarding their movement. For example, the wearable device may communicate, “Please exit the vehicle and look to the vehicle's left. You should see the main entrance of the shopping mall. Do you see it?” The user may then confirm that they see it such as by saying “Yes” or nodding their head up and down to indicate that they do, or just walking towards the main entrance. The wearable device may correct the user at any time or provide helpful prompts such as “Look towards the right.” Thus, directions and directional feedback from the earpiece may be provided in various ways to the user until they arrive at their intended destination.

It is further contemplated that once an individual decides to navigate to a certain place, portions of the journey may be made by vehicle and portions of the journey may be made by alternative means such as walking. Thus, for example, suppose the individual wishes to visit a particular store which happens to be inside a mall. The individual may make this decision while at home (or elsewhere) and may be outside of their vehicle at the time. The individual may then say “Take me to the nearest Apple Store” to a voice assistant associated with the wearable device either directly or indirectly through a mobile device or other device associated with the wearable device. Suppose the store is within a shopping mall. The directions can begin by telling the individual that they will need to drive. Once in the car, it is contemplated that navigation may be handed off from the earpieces to the vehicle navigation system. The vehicle navigation system may then route the individual to the mall or a parking spot near the mall. It is further contemplated that once the vehicle navigation system determines that the user has arrived at the destination of the shopping mall, the vehicle navigation system may then handoff navigation back to the wearable device such that the wearable device may be used to navigate the person on foot to the mall.

In some embodiments other types of wearable devices such as earpieces, watches, glasses, jewelry, and articles of clothing may be used. In addition, instead of a wearable device a mobile device such as, a phone having a GPS receiver or other type of geolocation receiver may be used. Inertial sensor readings may also be used.

It is further contemplated that the vehicle navigation system may be associated with an autonomous or self-driving vehicle. If this is the case, the handoff from the wearable devices or mobile device to the vehicle at the beginning of the journey and the handoff from the vehicle back to the wearable devices or mobile device after the end of the vehicle trip may be performed in a similar manner.

### Interactions Relating to Health or Physical Monitoring

Referring to FIG. 4, according to one aspect, the wearable devices 10 may communicate information through a vehicle network 100 associated with a vehicle 2. Data, instructions, alerts, or other information may be communicated over the vehicle network 100 or vehicle bus to and from the wearable devices 10. Protocols which may be used include a Controller Area Network (CAN), Local Interconnect Network (LIN), or others including proprietary network protocols or network protocol overlays.

Referring to FIG. 9, one or more wearable devices 10 (including one or more earpieces from one or more different vehicle occupants) may communicate with a navigation system 120 of a vehicle, an entertainment system 122 of a vehicle, or an autonomous control system 124 of a vehicle via the vehicle network 100. The wearable devices 10 may communicate head movement, glucose levels, heart rate, and body temperature. In addition, one or more alert conditions may be communicated via the vehicle network 100 as well. Although the communication may be performed directly between the navigation system 120 or entertainment system 122 and one or more of the wearable devices 10, in one embodiment a wireless transceiver associated with an electronic module 110 may be operatively connected to one or more wearable devices 10 after the wireless transceiver associated with the electronic module 110 connects with or forms a wireless linkage with one or more of the wearable devices 10. The wireless transceiver associated with an electronic module 110 may use any number of different is types of communications and protocols including Bluetooth, Bluetooth Low Energy (BLE), ultra-wideband, Wi-Fi, or other protocols. The vehicle network 100 may provide for communicating with any number of different modules or systems including a navigation system 120 and an entertainment system 122. The vehicle systems or modules may further include an autonomous control system 124 which is used for autonomous or self-driving of the vehicle. Based on the health data and or the alert condition(s) the vehicle, self-driving vehicle, or autonomous vehicle may then perform one or more actions related to the health data or alert conditions.

According to another aspect, one or more wearable devices may provide for health monitoring of an individual such as a driver or one or more passengers of the vehicle. The wearable devices may have any number of different sensors which may be used for monitoring the health of an individual or other physical parameters of an individual. Examples of sensors may include one or more inertial sensors such as an accelerometer, a gyro sensor or gyrometer, a magnetometer or another type of inertial sensor. As shown in FIG. 3, the sensor(s) 32 may also include one or more contact sensors 72, one or more bone conduction microphones 71, one or more air conduction microphones 70, a chemical sensor 79, a pulse oximeter 78, a temperature sensor 80, an alcohol sensor 83, a glucose sensor 85, a bilirubin sensor 87, a blood pressure sensor 82, an electroencephalogram (EEG) 84, an Adenosine Triphosphate (ATP) sensor, a lactic. acid sensor 88, a hemoglobin sensor 90, a hematocrit sensor 92, or other physiological or chemical sensor.

These various sensors may be used in any number of ways to provide feedback to the vehicle. For example, the sensors may be used to detect emergency conditions associated with an occupant of the vehicle. Where the wearable device is an earpiece, the inertial sensors may be used to track head movement of the driver. If the head movement of the driver indicates that the user is falling asleep, such as downward movement of the chin and then snapping back of the head as the user catches themselves falling asleep, or other movements associated with a user falling asleep, then the earpiece may communicate a message to the vehicle. Upon receipt of the message, the vehicle may take any number of relevant actions. This may include turning on loud music, opening one or more windows, adjusting environmental controls such as making the cabin temperature cooler, turning-on autonomous or self-driving operations if available or turned off, locating the nearest rest stop or hotel or motel and providing navigation directions to it, turning on emergency hazard lights, disabling the vehicle, providing one or more audio warnings, placing a phone call or any number of other actions ensuring the safety of the driver.

Another example of use of a sensor is use of a glucose sensor. If the blood sugar of an individual is low as measured with a wearable device or an earpiece, the wearable device or earpiece may communicate a message to the vehicle. Upon receipt of the message, the vehicle may take any number of relevant actions. These actions may include locating the nearest rest stop, restaurant, or gas station so that the individual may obtain something to eat, providing an audio message such as reminding the user to eat something, alerting occupants within the vehicle, turning on an autonomous mode and locking out the occupant from manual override and navigating to the nearest place where food is likely to be available, or any number of other actions related to alleviating the individual's blood sugar problem.

Another example of use of a sensor is use of an alcohol sensor. If the alcohol sensor detects that the driver may be impaired based upon blood alcohol levels, then the wearable device may communicate an appropriate message to the vehicle which may disable its operation, place it in an autonomous driving only mode so that the occupant cannot override the vehicle, provide an audio message, make a phone call, or perform any number of other actions.

Yet another example of use of a sensor is a pulse oximeter, If the pulse oximeter detects that the heart rate of the driver is increasing, then the wearable device may communicate a message containing the driver's heart rate information to the vehicle. The vehicle may combine the heart rate information with other information. For example, the vehicle may determine that it is currently in heavy traffic and that based on the driver's heart rate information, the driver may be frustrated. The vehicle may then respond in various ways such as by playing relaxing music or offering to play relaxing music, suggesting an alternative route or destination to avoid additional traffic congestion, or other alternatives based on the driver's preferences. As an additional example, if the wearable device detects heart rate indicative of a heart attack or other serious condition, an autonomous vehicle may drive to the nearest emergency room, place a call to an emergency responder and pull over to the side of the road or safe location, or take other appropriate actions. One or more passengers' heart rates may also be communicated to the vehicle using one or more wearable devices to be used in similar manners as previously described.

The various sensors may be used in any number of other ways including detecting or predicting health status which may be indicative of a health condition or event which may impair safe driving. Where the health condition or event may impair safe driving, an autonomous vehicle may lock vehicle controls so that the occupant cannot override autonomous vehicle functions. If the occupant is driving, then the autonomous vehicle may take over control from the occupant immediately.

### Interaction Between Vehicle Displays and Wearable Devices

Referring to FIG. 4, according to one aspect, the wearable devices 10 may communicate information through a vehicle network 100 associated with a vehicle 2. Data, instructions, input, commands, files, or audio streams may be communicated over the vehicle network 100 or vehicle bus to and from the wearable devices 10. Protocols which may be used include a Controller Area Network (CAN), Local Interconnect Network (LIN), or others including proprietary network protocols or network protocol overlays.

Referring to FIG. 9, one or more wearable devices 10 (including one or more earpieces from one or more different vehicle occupants) may communicate with an entertainment system 122 of a vehicle via the vehicle network 100. The wearable devices 10 may communicate head movement, glucose levels, heart rate, and body temperature. In addition, one or more alert conditions may be communicated via the vehicle network 100 as well. Although the communication may be performed directly between the navigation system 120, the entertainment system 122, or the vehicle display 126 and one or more wearable devices 10, in one embodiment a wireless transceiver associated with an electronic module 110 may be operatively connected to one or more wearable devices 10 after the wireless transceiver associated with the electronic module 110 connects with or forms a wireless linkage with one or more of the wearable devices 10. The wireless transceiver associated with an electronic module 110 may use any number of different types of communications and protocols including Bluetooth, Bluetooth Low Energy (BLE), ultra-wideband, Wi-Fi, or other protocols. The vehicle network 100 may provide for communicating with any number of different modules or systems including the navigation system 120, the entertainment system 122, and the vehicle display 126.

According to another aspect, the wearable devices 10 may use one or more displays of the vehicle to display information. Where the displays of the vehicle are touchscreen displays, the touchscreen displays may be used to provide input to the wearable devices 10. Similarly, other user controls or user interfaces of the vehicle may be used to provide input to or receive output from the wearable devices 10. These user controls or user interfaces may include navigation screens, entertainment screens, or any number of other screens or displays.

According to another aspect, there are various forms of interaction between the navigation system 120, the entertainment system 122, and the vehicle display 126 of a vehicle and one or more wearable devices 10. One type of interaction involves the transfer of data including information about audio or video files between the one or more wearable devices 10 and the vehicle display 126 which may be used by the entertainment system 122. It is contemplated that the entertainment system 122 associated with the vehicle may have large amounts of storage available, larger than may be available on the wearable devices 10. Thus, for example, if the wearable device 10 has sufficient storage available for storing music, one or more audio files or playlists may be transferred from the vehicle to the wearable device 10. Alternatively, one or more audio files or playlists may be transferred from the wearable device 10 to the vehicle. In addition, one or more audio tiles or playlists may be streamed from the entertainment system 122 of the vehicle to the wearable device 10 and one or more audio files or playlists may be streamed from the wearable device 10 to the entertainment system 122 of the vehicle. The vehicle display 126 may be used to display this information. In addition, data associated with health monitoring may be displayed on one or more vehicle displays 126 of the vehicle.

Similarly, there are various forms of interaction between the navigation system 120 of a vehicle and one or more wearable devices 10. In particular, a navigation system associated with one or more of the wearable devices 10 may integrate with the navigation system 120 of a vehicle. For example, one or more wearable devices 10 may provide a voice assistant for providing instructions to a user but one or more of the wearable devices 10 may not have a geolocation system such as a global positioning system (GPS) receiver, a GLOSNASS receiver or other geolocation system. However, one or more of the wearable devices 10 may have one or more inertial sensors which may be used to track the movement of an individual. Thus, to determine geolocation or geospatial position, one or more of the wearable devices 10 may communicate with a mobile device or vehicle navigation system which includes a geolocation system. It is further contemplated that once a wearable device 10 knows of or is calibrated to a particular geoposition, the wearable device may use information from its inertial sensors to update or track changes in its geoposition. Thus, location information may also be communicated to and from one or more of the wearable devices 10, The location information, whether a starting location, destination, or intermediary location may be displayed on the vehicle display 126.

According to another aspect, one or more wearable devices may provide for health monitoring of an individual such as a driver or one or more passengers of the vehicle. The wearable devices may have any number of different sensors which may be used for monitoring the health of an individual or other physical parameters of an individual, Examples of sensors may include one or more inertial sensors such as an accelerometer, a gyro sensor or gyrometer, a magnetometer or other type of inertial sensor. As shown in FIG. 3, the sensor(s) 32 may also include one or more contact sensors 72, one or more bone conduction microphones 71, one or more air conduction microphones 70, a chemical sensor 79, a pulse oximeter 78, a temperature sensor 80, an alcohol sensor 83, a glucose sensor 85, a bilirubin sensor 87, a blood pressure sensor 82, an electroencephalogram (EEG) 84, an Adenosine Triphosphate (ATP) sensor, a lactic acid sensor 88, a hemoglobin sensor 90, a hematocrit sensor 92, or other physiological or chemical sensor. Referring to FIG. 9, data associated with health monitoring maybe displayed on one or more vehicle displays 126 of the vehicle.

### Vehicle to Vehicle Communications

Referring, to FIG. 4, according to one aspect, the wearable devices 10 may communicate information through a vehicle network 100 associated with a vehicle 2. Data, instructions, alerts, or other information may be communicated over the vehicle network 100 or vehicle bus to and from the wearable devices 10. Protocols which may be used include a Controller Area Network (CAN), Local Interconnect Network (LIN), or others including proprietary network protocols or network protocol overlays.

Referring to FIG. 9, one or more wearable devices 10 (including one or more earpieces from. one or more different vehicle occupants) may communicate with a navigation system 120 of a vehicle, an entertainment system 122 of a vehicle, or an autonomous control system 124 of a vehicle via the vehicle network 100. Sensor data such as inertial sensor data and health monitoring data may be communicated to and from the vehicle network 100 via the wireless transceiver associated with an electronic module 110. In addition, one or more alert conditions may be communicated to and from the vehicle network 100 via the wireless transceiver associated with an electronic module 110 as well. Although the communication may be performed directly between the navigation system 120, the entertainment system 122, or the autonomous control system 124 and one or more of the wearable devices 10, in one embodiment a wireless transceiver associated with an electronic module 110 may be operatively connected to one or more wearable devices 10 after the wireless transceiver associated with the electronic module 110 connects with or forms a wireless linkage with one or more of the wearable devices 10. The wireless transceiver associated with an electronic module 110 may use any number of different types of communications and protocols including Bluetooth, Bluetooth Low Energy (BLE), ultra-wideband, or other protocols.

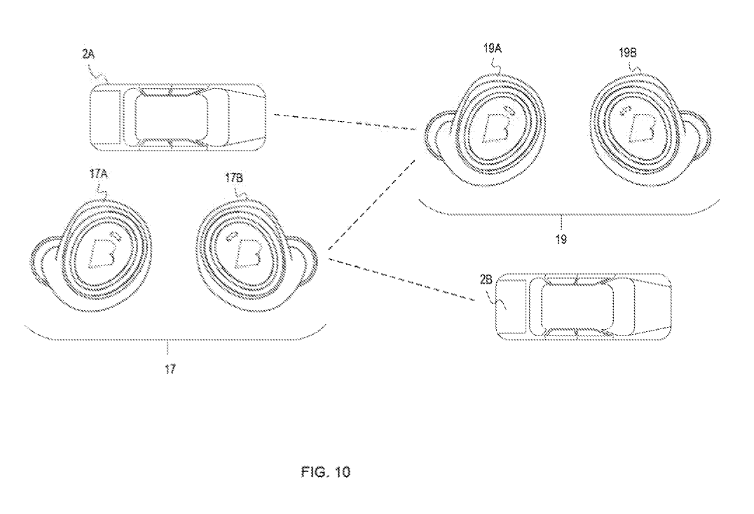

FIG. 10 illustrates a first vehicle 2A and a second vehicle 2B. There is a set of earpieces 17 associated with the first vehicle 2A such as may be worn by a driver of the first vehicle 2A or other occupant of the first vehicle 2A. There is a set of earpieces 19 associated with the second vehicle 2B such as may be worn by a driver of the second vehicle 2B or other occupant of the second vehicle 2B. There are several different communication scenarios shown in FIG. 10.

In one example, the vehicle 2A is in operative communication with earpieces 19 worn by a driver of the vehicle 2B. In this example, inertial sensors in the earpieces 19 may detect a sudden change in movement such as that associated with hard braking. In this instance an alert may be communicated to the vehicle 2A to warn the vehicle 2A that the vehicle in front of vehicle 2A, namely vehicle 2B is braking. The vehicle 2A may then perform any number of different actions in response to this alert. The actions taken by vehicle 2A may depend upon whether vehicle 2A is a self-driving/autonomous vehicle in a self-driving mode or whether vehicle 2A is being operated by a driver. If vehicle 2A is being operated by a driver, vehicle 2A may alert the driver of a possible dangerous condition through making a warning sound, providing a visual indicator, or otherwise alerting the driver. If vehicle 2A is operating autonomously, the vehicle may brake, change lanes, or perform an analysis based on the alert in addition to any other information the vehicle has acquired.

in another example, the earpieces 17 are in operative communication with the earpieces 10B. In this example, an alert may be communicated from earpieces 19 to earpieces 17 for the benefit of the driver of vehicle 2A who is wearing the earpieces 17. This may be an audio alert or other type of alert to warn the driver of vehicle 2A of a sudden movement associated with vehicle 2B.

Thus alert conditions may occur based on sensed data from one or more inertial sensors. Alert conditions may also occur based on driver or occupant health. Thus, for example if one or more of the physiological sensors detect an issue with a driver of a vehicle, an alert may be communicated to the second vehicle or to earpieces worn by a driver of the second vehicle. Thus, vehicle safety may be improved by providing advance or supplemental warning of sudden changes in one vehicle to a second vehicle or a driver of the second vehicle.

Any number of actions, processes, or so forth may be implemented utilizing one or more of the earpieces, vehicle systems, wireless devices, or other networked devices. In one example, the user may receive a phone call through a wireless device within the vehicle or by a communication system within the vehicle. In response to the user being authorized or authenticated, the user may provide feedback utilizing the wireless earpieces, such as a double head nod, thereby accepting the phone call for communication through the speakers and microphones of the vehicle. In addition, the communications may be communicated through the wireless earpieces and augmented by the vehicle communication systems (e.g., displaying the caller, call length, etc,).

In another example, the user may provide a verbal command, such as “enter sport mode”, thereby providing a command to the vehicle to adjust the performance of the vehicle (e.g., engine torque/output, transmission performance, suspension settings, etc.). The wireless earpieces may be configured to listen for or receive a command at any time. In other embodiments, a “listen” mode may be activated in response to an input, such as a finger tap of the wireless earpieces, initiation of a vehicle feature, head motion, or so forth. The listen mode may prepare the wireless earpieces to receive a command, input, or feedback from the user.

In another example, the wireless earpieces may provide a method of monitoring biometrics of the user, such as heart rate, blood pressure, blood oxygenation, respiration rate, head position, voice output, or other measurements or readings detectable by the various sensors within the wireless earpieces and/or the vehicle. For example, the wireless earpieces may determine that the user is fatigued based on the user's heart rate, respiration, and head motion in order to provide an alert through the vehicle systems, such as a message indicating that the user should pull over communicated through the infotainment system, a heads up display (e.g., electronic glass), or other vehicle systems. For example, the user settings may indicate that the windows are rolled down and the music is turned up until the user can find a suitable place to stop or park. The wireless earpieces may also warn the user if he is impaired based on a determined blood alcohol level, cognition test, slurred speech, or other relevant factors. As a result, the wireless earpieces may help protect the user from his or herself, passengers within the vehicle, and third parties that may be outside the vehicle. In one embodiment, the wireless earpieces may be configured to lock out one or more vehicle systems in response to determining the user is impaired.

The wireless earpieces may also indicate biometrics in the event there is an accident, health event, or so forth. For example, the wireless earpieces may send a command for the vehicle to enter an emergency pullover mode in response to determining the user is experiencing a health event, such as a heart attack, stroke, seizure, or other event or condition that prevents the user from safely operating the vehicle. The wireless earpieces may also send one or more communications to emergency services, emergency contacts, or so forth.

In another example, the wireless earpieces may be utilized to monitor a younger or inexperienced user operating the vehicle. For example, to operate the vehicle, an administrator of the vehicle may require that the wireless earpieces be worn to determine the watchfulness of the user determined by factors, such as head position, conversations or audio detected, activation/utilization of and associated cellular phone, the wireless earpieces, or the vehicle systems. As a result, the wireless earpieces may be utilized as a parental monitoring feature wall the user is within the vehicle.

The wireless earpieces may also be utilized to perform any number of small tasks that may significantly enhance the user experience, such as opening individual doors, unlocking the trunk, opening windows/sunroofs starting the vehicle, turning off the vehicle, turning on or off the air conditioning/heater, adjust a seat configuration, turning on a movie/music, or any number of other features commonly utilized by the user, The wireless earpieces in conjunction with the vehicle systems, may also learn the preferences of the user over time in order to perform automatic features and settings of the vehicle.

It is further contemplated that particular commands may be automatically communicated based on the identity of the user. In other words, once, the user has been identified the vehicle may perform one or more vehicle functions automatically based on the identity of the user. These functions may be any number of different functions previously discussed including functions that grant access or deny access to the user.

Various methods, system, and apparatus have been shown and described relating to vehicles with wearable integration or communication. The illustrative embodiments are not to be limited to these specific examples but contemplate any number of related methods, systems, and apparatus and these examples may vary based on the specific type of vehicle, the specific type of wearable device, the various types of health conditions and health data, the alert conditions where present, and the actions taken in response to health data and other considerations.

What is claimed is:

1. A system comprising:
a vehicle, the vehicle comprising a control system; and
a wireless transceiver operatively connected to the control system;
wherein the control system is configured to wirelessly communicate with a wearable device worn by a user using the wireless transceiver; and
wherein the control system is configured to receive input from one or more sensors of the wearable device.

2. The system of claim 1 wherein the control system is configured to identify a user of the wearable device based on information from the wearable device.

3. The system of claim 2 wherein the control system is configured to alter one or more vehicle settings based on the identity of the user.

4. The system of claim 1 wherein the control system is configured to send the wearable device a geospatial location.

5. The system of claim 1 wherein the control system is configured to receive a destination from the wearable device and communicate the destination to a navigation system operatively connected to the control system.

6. The system of claim 1 wherein the control system is configured to send or receive content for text messages to the wearable device.

7. The system of claim 1 wherein the control system is configured to connect a phone call to the wearable device.

8. The system of claim 1 wherein the control system is configured to send or receive one or more files to or from the wearable device.

9. The system of claim 1 wherein the control system is configured to perform one or more driving operations in response to the input from the one or more sensors of the wearable device.

10. The system of claim 1 wherein the wearable device comprises an earpiece.

11. The system of claim 10 wherein the earpiece is configured to allow ambient sound to pass to an external auditory canal of the user.

12. The system of claim 10 wherein the earpiece is configured to reproduce ambient sound at a speaker of the earpiece.

13. The system of claim 10 wherein the vehicle comprises a microphone positioned outside of a vehicle cabin to capture outside the vehicle sound and wherein the earpiece is configured to reproduce the outside the vehicle sound.

14. A system comprising:
a vehicle, the vehicle comprising a control system; and
a wireless transceiver operatively connected to the control system;
wherein the control system is configured to wirelessly communicate with a wearable device worn by a user using the wireless transceiver; and
wherein the control system is configured to receive biometric input from one or more sensors of the wearable device to identify an occupant of the vehicle or individual proximate the vehicle.

15. The system of claim 14 wherein the control system is configured to provide access to the vehicle after identifying the occupant of the vehicle or the individual proximate the vehicle.

16. The system of claim 15 wherein the access is provided by unlocking an ignition of the vehicle.

17. The system of claim 15 wherein the access is provided by opening a door or compartment of the vehicle.

18. The system of claim 14 wherein the control system is configured to deny access to the vehicle after identifying the occupant of the vehicle or the individual proximate the vehicle.

19. The system of claim 14 wherein the control system is configured to alter one or more vehicle settings based on an identity of the user or the individual proximate the vehicle.

20. The system of claim 14 wherein the wearable device comprises an earpiece.
